(19) United States
(12) Patent Application Publication
(10) Pub. No.: US 2008/0319809 A1
(43) Pub. Date: Dec. 25, 2008

(54) SYSTEM AND METHOD OF MAINTAINING CONTRACTS IN BUSINESS PROCESS MANAGEMENT

(75) Inventors: Michael W. Brown, Georgetown, TX (US); Eric N. Herness, Byron, MN (US); Kevin S. Barker, Raleigh, NC (US); Stefan G. Derdak, San Jose, CA (US)

Correspondence Address: PATENT INGENUITY, PC, 520 BROADWAY, SUITE 350, SANTA MONICA, CA, 90401, US

(73) Assignee: INTERNATIONAL BUSINESS MACHINES CORPORATION, Armonk, NY (US)

(21) Appl. No.: 11/765,803

(22) Filed: Jun. 20, 2007

(51) Int. Cl. G06F 9/44

(52) U.S. Cl. 705/7

(57) ABSTRACT

A system and method for establishing and maintaining a contract between a business process model and a monitoring module corresponding to a portion of the business process model is disclosed. In the modeling task, a contract is established and associated with an event in the business process flow. The contract specifies a relationship between the event within the business process model and a monitoring module that is configured to monitor the event. Therefore, if changes are made to the event or process, a user will be warned that the changes may affect an existing monitoring module that exists to monitor this process.

### BACKGROUND

1. Field

This disclosure relates to business process management. More specifically this disclosure relates to establishing and maintaining contracts between a business process model and a monitoring module configured to measure performance of the business process model.

2. General Background

Business Process Management (“BPM)” is a field at the intersection between Management and Information Technology (“IT”). BPM encompasses methods, techniques and tools to design, enact, control, and analyze business processes involving humans, organizations, applications, documents and other sources of information.

BPM includes activities performed by organizations to manage and, if necessary, to improve their business processes. Software tools called business process management systems (“BPM systems”) have made such activities faster and less expensive. BPM systems monitor the execution of the business processes so that managers can analyze and change processes in response to data, rather than just a hunch. The activities which constitute business process management can be grouped into three categories: design, execution and monitoring.

Process design encompasses the design and capture of existing business processes, as well as the simulation of new processes. The software used to do this includes graphical editors or modelers that document processes, repositories that store process models, and business process simulation tools that run a process a large number of times in order to measure performance parameters, e.g., average time and cost.

A traditional way to automate processes is to develop or purchase a software application that executes the required tasks of the process. However, in reality, these software applications rarely execute all the tasks of the process accurately or completely. Another approach is to use a federation of software and human intervention. The federated approach is complex, which makes documenting a process difficult. Without documentation for the process, making a modification to improve the process is also difficult.

In response to these problems, software developers have developed software that enables the full business process (as developed in the process design activity) to be defined in a computer language which can be directly executed by the computer. The system will either use services in connected applications to perform business operations, e.g., calculating a repayment plan for a loan, or, when a task is too complex to automate, will message a human requesting input. Compared to either of the previous approaches, directly executing a process definition is much more straightforward and therefore easier to improve. However, automating a process definition requires a flexible and comprehensive infrastructure, which typically rules out implementing these systems in a legacy IT environment.

The commercial BPM software market has focused on graphical process model development, rather than text-language based process models, as an approach to reduce the complexity of model development. Visual programming using graphical metaphors has increased productivity in a number of areas of computing.

Monitoring encompasses the tracking of individual processes so that information on the state of the individual process can be easily seen. Monitoring also provides useful statistics on the performance of one or more processes. An example of the tracking is the ability to determine the state of a customer order, e.g. ordered, arrived, awaiting delivery, invoice paid, so that problems in its operation can be identified and corrected. In addition, this information can be used to work with customers and suppliers to improve their connected processes. Examples of the statistics are the generation of measures on how quickly a customer order is processed, how many orders were processed in the last month, etc.

Although the tasks of modeling, implementation, and monitoring are related, each task is performed separately and using different software applications. Therefore, although changes made to a process model affect the monitoring of the process, there is currently no linkage between the tasks.

### SUMMARY

In one aspect, a method for establishing and maintaining contracts between a business process model and a monitoring module is disclosed. The method comprises receiving contract data. The contract data specifies a contract that exists between an event within a business process model and a monitoring module which is configured to measure performance related to the event. The contract data is then associated with the business process model. The business process model is periodically validated to ensure the business process model adheres to the contract data. A notification is provided if it is determined that the business process model does not adhere to the contract data.

In another aspect, a system for establishing and maintaining contracts in a business process management system is disclosed. The system comprises a business process model and a monitoring module configured to measure performance of an event within the business process model. A contract data module is associated with the business process model. The contract data module stores a contract field of a contract data set, the contract field including data specifying a relationship between an event within the business process model and the monitoring module. A validator ensures the business process model adheres to the data specified in the contract field. A notification module is configured to provide a notification when the business process model does not adhere to the data specified in the contract field.

According to another aspect of the present disclosure, there is also provided a computer executable program for executing steps of the above method, a machine readable storage medium with codes of the computer executable program stored thereon, and a computer program product with codes of the computer program encoded thereon.

### DRAWINGS

The above-mentioned features and objects of the present disclosure will become more apparent with reference to the following description taken in conjunction with the accompanying drawings wherein like reference numerals denote like elements and in which:

FIG. 1 illustrates a block flow diagram of a method of business process management in accordance with one aspect of the disclosure.

FIG. 2 illustrates an exemplary embodiment of a system of business process management in accordance with the present disclosure.

FIG. 3 illustrates an example of a business process flow model.

FIG. 4 illustrates a flow diagram of maintaining a contract between a business process model and a monitor.

FIG. 5 illustrates a system that utilizes a contract maintenance module.

### DETAILED DESCRIPTION

A system and method for establishing and maintaining a contract between a business process model and a monitoring module (also referred to as “monitor”) corresponding to a portion of the business process model is disclosed. In the modeling task, a contract is established and associated with an event in the business process flow. The contract specifies a relationship between the event within the business process model and a monitoring module that is configured to monitor the event. Therefore, if changes are made to the event or process, a user will be warned that the changes may affect an existing monitoring module that exists to monitor this process.

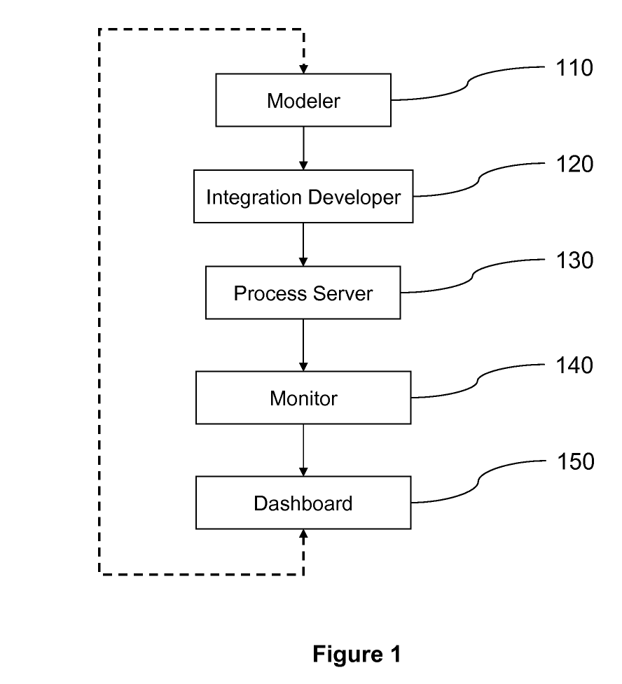

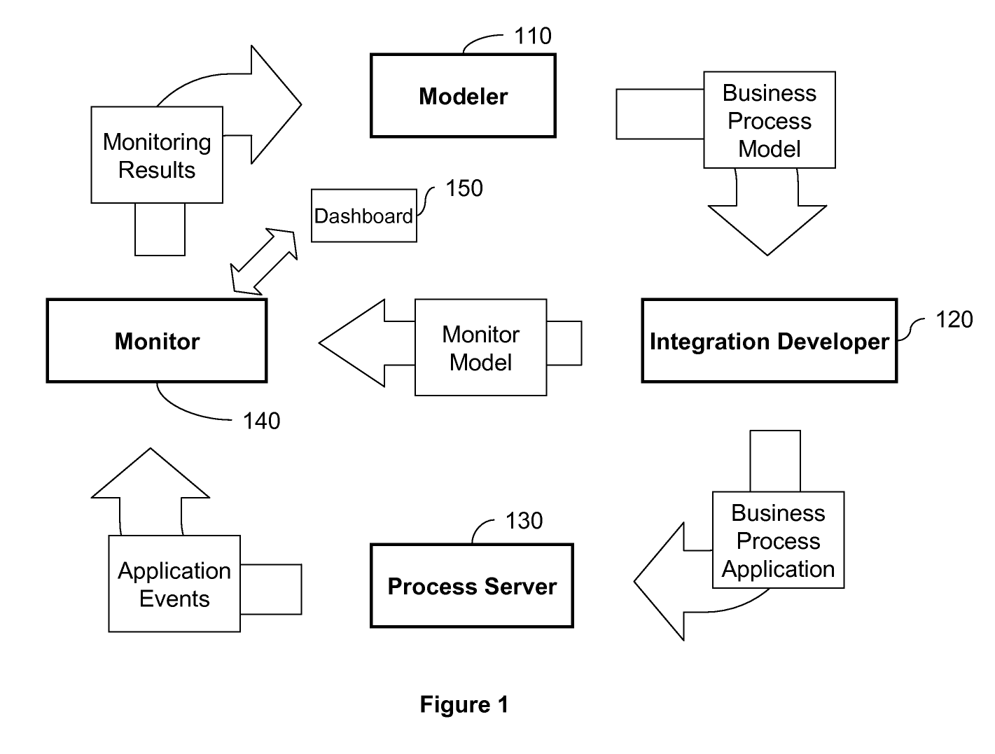

FIG. 1 illustrates a block flow diagram of a business process management method in accordance with one aspect of the disclosure. The first step in a business process management cycle generally involves creating a model of the business process, as indicated by block 110. Business processes are a series of related business activities aimed at achieving one or more business objectives in a measurable manner. Examples of typical business processes include receiving orders, marketing services, selling products, delivering services, distributing products, invoicing for services, and accounting for money received. A business process represents how work is completed across internal and external organizations by describing how a business harnesses performers (people and application systems) and passive resources (knowledge, equipment, physical assets, capital) in order to execute the capabilities of these resources, realize the strategic capabilities and value propositions, and to create valuable outcomes. Creating a model of the business process allows a user to isolate, break down, expose, or explore components of a business process. The task of creating a business process model is often performed by a business person or manager. Creating a business process model is similar to creating a block flow diagram, whereby a process is broken down into several steps that occur in an order, and are linked together to indicate the progression of tasks.

Once a business process model has been created, a business process software application is developed as is indicated at block 120. The business process software application is a software application designed to perform the tasks as specified by the business process model. The task of developing the business process application is usually performed by a software developer or programmer. Creating the business process application can be accomplished in several ways. In one aspect, the application may be created by writing code and building a customized application “from scratch”. In another aspect, the application may be developed through use of a software application designed to develop such business process applications based on a business process model.

At a next block 130, the business process application is deployed and executed. Finally, a monitor is built and deployed so that performance of the business process application can be measured, as is indicated by block 140. The monitor captures real-time and historical data to allow a business to analyze and evaluate the performance of the software application. Analysis of real-time event data and other business data, including historical data on business operations, is helpful in diagnosing business performance problems, evaluating the various decision alternatives, and planning the appropriate corrective action for any particular business performance management situation that is detected.

The business process management cycle is intended to allow businesses to develop and fine tune a business process application by monitoring the performance and making changes to the application in view of the monitored performance. However, in many cases, such fine tuning or changes made to the business process model could render one or more monitors configured to measure performance of the business process application, and generate necessary reports, inoperable. For example, as discussed above, a monitor is deployed to record performance data related to some aspect of the business process application. If a change is made to that portion of the business process model, and the business process application is revised accordingly, then an existing monitor configured to watch the portion of the business process application that was changed would likely no longer be effective in monitoring the business process application properly.

For example, a business modeler may add a branch to the business process flow model. A monitor already exists to monitor the existing branch, but now the monitor should be watching the newly added branch. In another example, an operational report depends on a monitor to record how long it took for a user to complete a task, but the application developer decides to remove the monitor corresponding to the activity because he did not know it was needed. Such situations can be avoided by establishing and maintaining a contract between an event in the business process model and a corresponding monitor throughout the business process management cycle.

Therefore, a contract 150, as represented by the dotted line in FIG. 1, is established between the business process modeling task and the monitoring task. In the modeling step, a contract is established and associated with an event in the business process model. The contract specifies a relationship between an event within the business process model and a monitor that exists to measure performance related to this event. The contract also specifies what event should occur if the contract is broken. For example, the contract might specify that a message warning the user should be displayed. Alternatively, the user could be prevented from making changes to the model that would negatively impact a corresponding monitor.

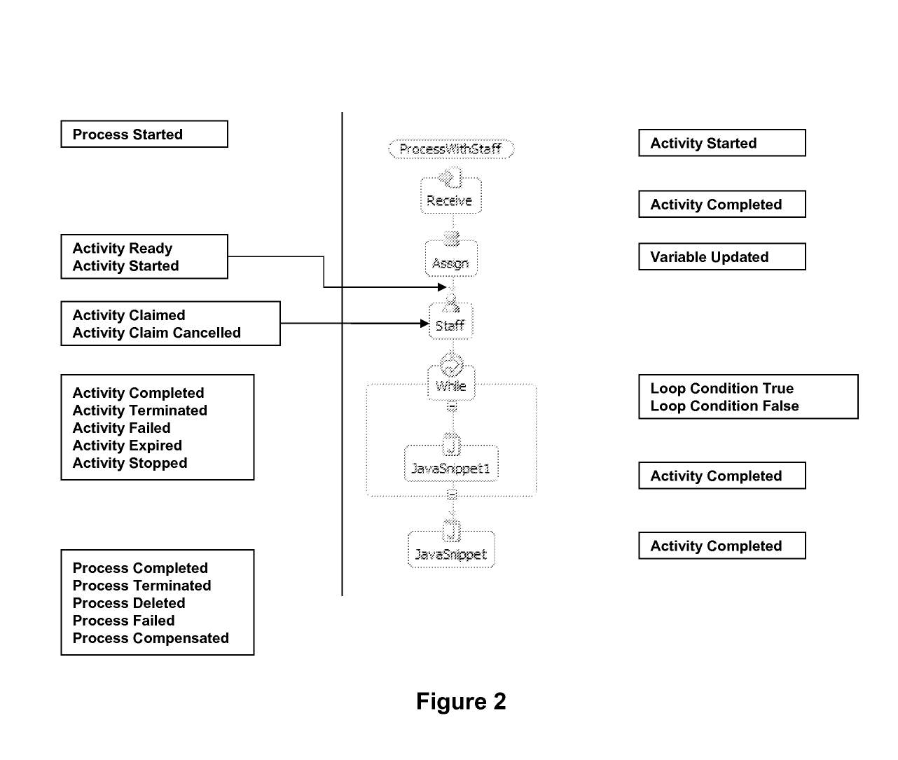

FIG. 2 illustrates an exemplary embodiment of a system of business process management in accordance with the present disclosure. Modeler 210 is used to create a business process model. As an example, the modeler 210 may be a business modeling software application such as IBM's WebSphere Business Modeler. Modeler 210 is initially used for creating the business process model. However, simulation and analysis on the model is later performed by the modeler 210 in order to optimize the model.

Modeler 210 is adapted to provide entry for a contract field to be associated with each event of a business process model. The contract field specifies that there is an existing monitor associated with the event. The monitor is generally configured to measure some aspect related to performance of the event. The contract field may additionally specify other criteria such as a version number, notes, or error handling data.

Once a business process model 215 has been created, the model is then implemented as one or more software applications or processes. In one aspect, the business process model 215 created using modeler 210 can be exported as Business Process Execution Language (“BPEL”) to an Integration Developer 220, which is another software application which aids in implementing the business process model as an executable. An example of the Integration Developer 220 is the IBM Integration Developer, which aids in building Service Oriented Architecture (SOA) based integration solutions. Integration Developer 220 helps by mapping the business process model activities to service components to construct an application. The Integration Developer 220 is a tool for developing business process applications, and many other applications and/or methods can be used for developing the business process application 225.

In one aspect, the contract field from the business process model is carried over to the application development stage. Version tags may be used to represent different versions of the contracts. Validators and tooling ensure the definition of and execution of the contracts are understood and adhered to.

Once the business process application 225 has been developed, it is executed on a Process Server 230. An example of the Process Server 230 is the IBM WebSphere Process Server, which supports solutions created based on SOA. The Process Server 230 provides a production server to run and manage the application that has been created. Use of the WebSphere Process Server is an example, and the business process application 225 may be executed in other environments.

As the business process application 225 runs, various application events 235 occur. Monitor 240 is used to monitor the application events 235. Monitor 240 is the feedback mechanism that provides visibility of performance problems on a real-time basis and the opportunity to optimize business operations. Process visibility allows the business to identify issues or bottlenecks as they occur, rather than through indirect reporting, which may not have an accurate picture of what is occurring at the time that it is occurring.

In one aspect, an observation model may also be created. The observation model allow business analysts to design the metrics, counters, timers, triggers, and other performance management artifacts that are used at runtime by the monitor 240. An example of the monitor 240 is the IBM WebSphere Business Monitor. The observation model 242 created in the modeler is deployed to the monitor 240 for execution. Monitor 210 works by processing the events generated by Process Server 230 automatically upon state changes of running instances of service components. As defined in the observation model 242, monitor 240 looks for specific events and uses them to calculate the business measures. Events are stored in monitor 240's database and are replicated to other data stores used by monitor dashboards 245, one for real-time and another for historical reporting.

Dashboard 245 is a display that summarizes the vast amount of data as recorded by the monitor 240 into simple, intuitive measures to convey essential information. This information facilitates directed actions, decisions making, and optimization. The dashboard is for example an application which runs on a desktop of a business manager, such that the performance of the business application can be reviewed by a person.

A business process management lifecycle is fully achieved only if an appropriate feedback loop exists. Therefore, monitor 240 provides performance data/monitoring results 250 which are fed back to the modeler 210, so that the business process can be fine tuned and improved upon.

When continuous improvement exercises occur such as changing the model to improve the business process, validators ensure that contracts are not broken by the change. If a change is made that would break a contract, a reporting system is provided to inform the user etc. that a change has occurred that will render a monitor inoperable. Alternatively, the changes can be rejected such that the contract is not broken.

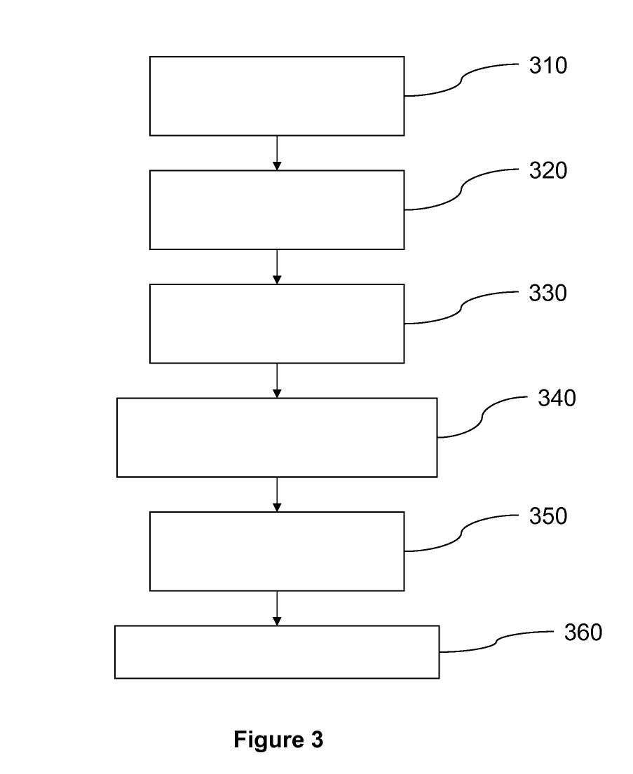

FIG. 3 illustrates an example of a business process model 300 as viewed within a business process modeling application. The business process model 300 comprises a plurality of activities. For example, each of the blocks 310, 320, 330 in business process model 300 represent an activity. Each activity may further have one or more events associated with the activity. There may be an event indicating the start of an activity and an event indicating the completion of an activity. Examples of various events that may occur with respect to an activity are listed in the boxes.

In this example of a business process model 300, an order by a customer is received at step 310 labeled “Receive”. The order is then assigned to an entity, as indicated by activity 320 labeled “Assign”. In this case, the order is assigned to a staff person for processing, as indicated by activity 330 labeled “Staff.” The staff person is to perform some activity with respect to the order. There could be several events that occur relating to the activity as performed by the staff person. The various events that may occur relating to activity 330 are listed in box 340. In most cases, the activity is successfully completed, as indicated by event 350 labeled “Activity Completed”. However, the activity could also have terminated, failed, expired, or stopped.

In order to analyze how often the activity is successfully completed, or perhaps how long it took for a staff person to compete the activity, a monitor is created to record data relating to the event “Activity Completed”. Furthermore, a report called “Staff Completion Report” is created which utilizes the data recorded by the monitor. After analyzing the report, management feels that the business process would be improved if activity 330 was performed by an automated software process instead of a staff person. Therefore, the business process model is revised accordingly, by deleting the old activity 330 and replacing it with an automated process.

In contrast to previous approaches where deletion of a portion of the business process model that had a corresponding monitor configured to measure performance of that portion would most likely render the monitor inoperable, the present disclosure provides for a contract field of a contract data set to be associated with each element of the business process model. A contact data module may store the contract field of the contract data set.

A field for defining such a contract may contain the following content:

<contract>Staff Completion Report
<version>1.0</v>
<event>Staff Activity Completed
<version>1.2</v>
<note from process> This event is for staff flows only </n>
</e>
<qos>always</q>
<note from contract>The Staff Completion Report needs to be informed
of all staff activities that are completed</n>
</contract>

In the above example, the contract specifies that a monitor exists called “Staff Completion Report” that is configured to monitor some aspect of the event “Staff Activity Completed.” The contract field labeled “version” above also suggests that this is version 1.0 of the contract. Furthermore, there is a “notes from process” field which points out that the event “Staff Activity Completed” within the business process model is for staff flows only (not for an automated process). Another notes field “notes from contract” may provide a message to the user in case the contract is broken. In this case, the user is notified that a staff completion report exists, which depends on completion of staff activities.

The above tag group is an example only. In the above example, tags are provided in Extensible Markup Language (“XML”). However, another language or methodology may be used for defining a contract.

A validator is provided for determining if the contracts are met. The validator is an algorithm which analyzes the content of the contract fields and determines if the business process model adheres to the data specified within the contract field. In one aspect, the validator checks to make sure that the monitor specified in the contract as corresponding to an event exists. Similarly, in another aspect the validator checks that the event corresponding with a monitor specified in the contract exists, and has not been removed.

In one aspect, the validator is executed each time a business process flow is saved, built, deployed, or run. If the validator determines that the business process model no longer adheres to the contract, a notification is provided to the user. The notification may simply be an error or warning message, advising that a contract has been broken, which may result in one or more monitors not functioning properly. However, in some aspects, the notification may prevent changes from being made to the business process model that result in a contract being broken. In the example described above, removing an event and replacing it with another event would result in the contract being broken since the event for which the contract specified no longer exists. Therefore, the user would be notified to address the problem, either by making a change to the contract, or making a corresponding change to the event or monitor so that the contract is not broken. In one aspect, the validator is part of a business process modeling software application.

In one aspect, the monitor is defined by an observation model. In this case, the contract may specify a relationship between an event and an observation model which defines the monitor for the event.

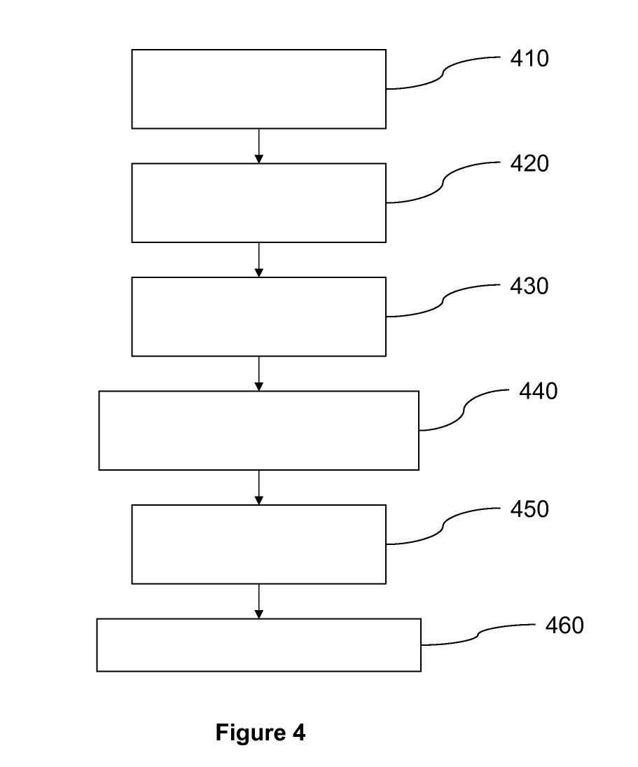

FIG. 4 is a flow diagram of a method for establishing and maintaining a contract between a business process model and a monitoring module. The method initially comprises receiving contract data, as is indicated at block 410. In one aspect, the contract data is received by a business process modeling software application. The contract data specifies a contract that exists between an event within a business process model and a monitoring module which is configured to measure performance related to the event. The contract data is then associated with the business process model, as shown at block 420. A validator periodically analyzes the business process model in view of the contract data to ensure that the business process model adheres to the contract data. This validation step is indicated at block 430. Finally, a notification is provided to a user if it is determined that the business process model does not adhere to the contract data, as is shown at block 440.

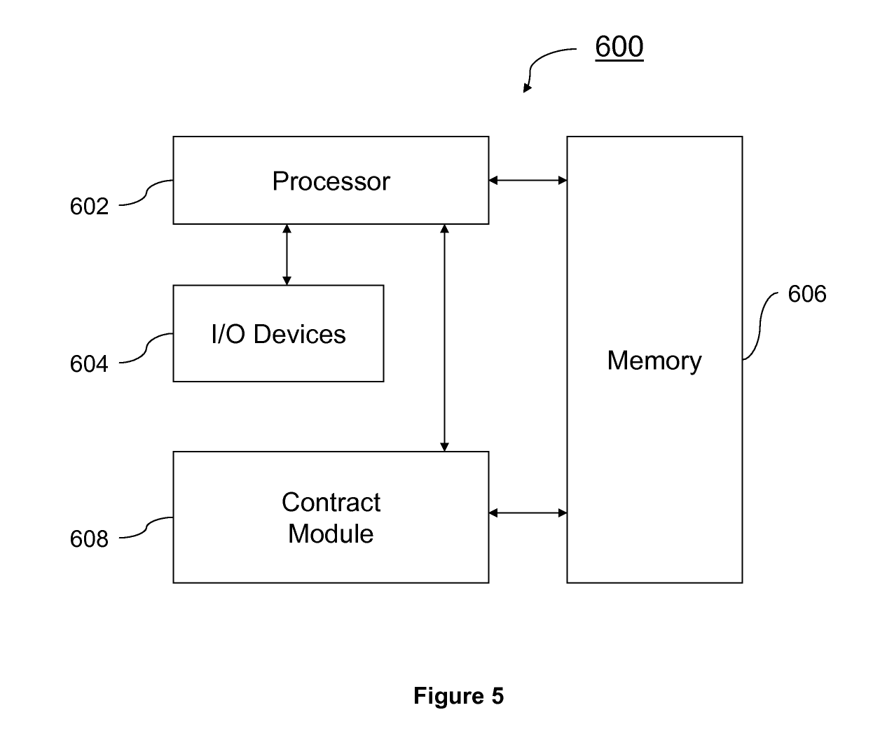

FIG. 5 illustrates a block diagram of a system 500 that utilizes a contract maintenance module in a business process management system. In one embodiment, the system 500 is suitable for storing and/or executing program code and is implemented using a general purpose computer or any other hardware equivalents. Thus, the system 500 comprises a processor 502, a memory 506, e.g., random access memory (“RAM”) and/or read only memory (“ROM”), a contract maintenance model 508, and various I/O devices 504.

The processor 502 is coupled, either directly or indirectly, to the memory 506 through a system bus. The memory 506 can include local memory employed during actual execution of the program code, bulk storage, and/or cache memories which provide temporary storage of at least some program code in order to reduce the number of times code must be retrieved from bulk storage during execution.

The I/O devices 504 can be coupled directly to the system 500 or through intervening input/output controllers. Further, the I/O devices 504 can include a keyboard, a keypad, a mouse, a microphone for capturing speech commands, a pointing device, and other user input devices that will be recognized by one of ordinary skill in the art. Further, the I/O devices 504 can include a receiver, transmitter, speaker, display, image capture sensor, biometric sensor, etc. In addition, the I/O devices 504 can include storage devices such as a tape drive, floppy drive, hard disk drive, compact disk (“CD”) drive, etc.

Network adapters may also be coupled to the system 500 to enable the system 500 to become coupled to other systems, remote printers, or storage devices through intervening private or public networks. Modems, cable modems, and Ethernet cards are just a few of the currently available types of network adapters.

It should be understood that the method and system described herein can take the form of an entirely hardware embodiment, an entirely software embodiment, or an embodiment containing both hardware and software elements. If software is utilized to implement the method or system, the software can include but is not limited to firmware, resident software, microcode, etc.

Further, the method and/or system can take the form of a computer program product accessible from a computer-usable or computer-readable medium providing program code for use by or in connection with a computer or any instruction execution system. For the purpose of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a RAM, a ROM, a rigid magnetic disk and an optical disk. Current examples of optical disks include CD—read only memory (“CD-ROM”), CD—read/write (“CD-R/W”) and DVD.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so to encompass all such modifications and similar structures. The present disclosure includes any and all embodiments of the following claims.

*IBM and WebSphere are registered trademarks of International Business Machines Corporation in the United States, other countries, or both.

1. A computer program product comprising a computer useable medium having a computer readable program, wherein the computer readable program when executed on a computer causes the computer to:
receive contract data, the contract data specifying a contract that exists between an event within a business process model and a monitoring module configured to measure performance related to the event;
associate the contract data with the business process model;
validate that the business process model adheres to the contract data; and
provide a notification if the business process model does not adhere to the contract data.

2. The computer program product of claim 1 wherein the computer readable medium when executed on the computer further causes the computer to validate that the business process model adheres to the contract data upon an attempt to modify the business process model.

3. The computer program product of claim 1 wherein the computer readable medium when executed on the computer further causes the computer to validate that the business process model adheres to the contract data when the business process model is executed.

4. The computer program product of claim 1 wherein the computer readable medium when executed on the computer further causes the computer to validate that the business process model adheres to the contract data when the business process model is prompted to be saved.

5. The computer program product of claim 1 wherein the notification includes a warning.

6. The computer program product of claim 2 wherein the notification prevents the user from modifying the business process model.

7. The computer program product of claim 4 wherein the notification prevents the business process model from being saved until a user makes a modification such that the contract is met.

8. The computer program product of claim 1 wherein the business process model is implemented as a business process application, and the monitoring module is configured to measure performance of a portion of the business process application corresponding to the event.

9. The computer program product of claim 1 wherein the computer readable medium when executed on the computer further causes the computer to extend the contract data to determine that a business process application based on the business process model also adheres to the contract.

10. The computer program product of claim 1 wherein the computer program product is a business process modeling software application.

11. The computer program product of claim 10 wherein the monitoring module is a software application external to the business process modeling software application.

12. The computer program product of claim 1 wherein the monitoring module is defined by an observation model.

13. The computer program product of claim 1 wherein the contract data includes one or more tags that are composed according to a markup language format.

14. A system comprising:
a business process model;
a monitoring module configured to measure performance of an event within the business process model;
a contract data module associated with the business process model, the contract data module storing a contract field of a contract data set, the contract field including data specifying a relationship between an event within the business process model and the monitoring module;
a validator for ensuring the business process model adheres to the data specified in the contract field; and
a notification module configured to provide a notification when the business process model does not adhere to the data specified in the contract field.

15. The system of claim 14 wherein the notification module provides an error.

16. The system of claim 14 wherein the validator executes upon an attempt to modify the business process model.

17. The system of claim 14 wherein the validator executes when the business process model is executed.

18. The system of claim 14 wherein the validator executes when the business process model is prompted to be saved.

19. The system of claim 16 wherein the notification module prevents a user from modifying the business process model.

20. The system of claim 18 wherein the notification module prevents the business process model from being saved until a user makes a modification such that the contract is met.

21. The system of claim 14 wherein the business process model is implemented as a business process application and the monitoring module is configured to measure performance of a portion of the business process application corresponding to the event.

22. The system of claim 14 wherein the validator is further configured to extend the contract data to determine that a business process application based on the business process model also adheres to the contract.

23. The system of claim 14 wherein the monitoring module is defined by an observation model.

24. The system of claim 14 wherein the contract data includes one or more tags that are composed according to a markup language format.

25. A method comprising:
receiving contract data, the contract data specifying a contract that exists between an event within a business process model and a monitoring module configured to measure performance related to the event;
associating the contract data with the business process model;
validating that the business process model adheres to the contract data; and
providing a notification if the business process model does not adhere to the contract data.

26. The method of claim 25 wherein validating occurs upon an attempt to modify the business process model.

27. The method of claim 25 wherein validating occurs when the business process model is executed.

28. The method of claim 25 wherein validating occurs when the business process model is prompted to be saved.

29. The method of claim 25 wherein the notification includes a warning.

30. The method of claim 26 wherein the notification prevents a user from modifying the business process model.

31. The method of claim 28 wherein the notification prevents the business process model from being saved until the user makes a modification such that the contract is met.

32. The method of claim 25 further comprising extending the contract to determine that a business process application based on the business process model also adheres to the contract.

33. The method of claim 25 wherein the method is performed by a business process modeling software application.

34. The method of claim 33 wherein the monitoring module is an application external to the business process modeling software application.

35. The method of claim 25 wherein the monitoring module is defined by an observation model.
